(19) United States
(12) Patent Application Publication
(10) Pub. No.: US 2024/0152973 A1
(43) Pub. Date: May 9, 2024

(54) System And Methods For Creating, Organizing, Publishing, And Disseminating Data-Files With Finite Lifetimes In Real-Time

(71) Applicant: Sachin Mehta, Colorado Springs, CO (US)

(72) Inventor: Sachin Mehta, Colorado Springs, CO (US)

(21) Appl. No.: 16/405,925

(22) Filed: May 7, 2019

(51) Int. Cl. G06Q 30/0241; G06Q 30/0273

(52) U.S. Cl. CPC G06Q 30/0276; G06Q 30/0273; G06Q 30/0277

(57) ABSTRACT

The present invention offers systems, methods, and tools for generating real-time coupon/advertisement data-files that may be housed in a database and may be searched for, or retrieved by, data-file users at any time using keyword, subject, and geo-location. Thus, the present invention offers creators of data-files, who may be merchants having businesses, similar features to that of traditional print advertisements but at significantly reduced costs and with much added flexibility. Creators of data-files are able to utilize the systems and methods to create need-specific real-time advertisements, coupons, and offers without online intermediaries or other third party involvement, such as sales persons or marketing teams, resulting in the reduction of overall expenses for marketing the merchant's business.

### CROSS-REFERENCES TO RELATED APPLICATIONS

This non-provisional utility application takes priority to the previously filed provisional application: Application No. 62/668,818 filed May 9, 2018, which is hereby incorporated in its entirety by reference.

### BACKGROUND OF THE INVENTION

Coupons and other related products are an important part of marketing and sales for all businesses. Print advertisements have been used for many years, however their high costs and relatively low customer penetration potential keeps businesses from fully utilizing this method as a means to attract and incentivize more customers. The advent of the Internet has provided a new means for merchants to reach out and entice larger numbers of potential consumers, however it is currently a time-consuming process that can fail to yield significant return on investment for smaller-scale businesses. For example, many merchants use mass emails to communicate discount offers to consumers, which more often than not end up in data-file users spam folders. There are also existing systems where third-party intermediaries will produce and publish coupons on their own websites on behalf of merchants/retailers, but for a large fee. Such offers are typically offered in the form of an online e-coupon, which may be applied towards the purchase of varying products or services offered by the retailer. These types of services can cost a great deal, have to be agreed upon through hefty disclaimers/contracts, and are simply not convenient for the millions of small businesses around the world.

### SUMMARY

The present invention relates to business systems and methods for creation, publication, and dissemination of digital data-files-in real-time-which have preset, finite lifetimes set by the data-file creator and may be housed in a one-stop database or repository of data-files. The system provides the uniqueness of automatically propagating these on-demand data-files rapidly into the public eye for finite time in formats such as advertising and marketing material, instant news, journalistic items, public comments sections, official announcements and dissemination materials etc. More particularly, the present invention relates to methods, systems, and tools for creating electronic data-files with predetermined expiration life cycles that the creators of the data-file(s) (who may be merchants or other retailers) may utilize for their business. More specifically, the present invention relates to the generation of electronic advertisement coupon data-files with preset, finite life-cycle that any given merchant can create for dissemination and distribution, and later for redemption by one or more data-file users. Furthermore, the present invention can help creators of data-files to collect sales leads for future marketing purposes. The present invention offers systems, methods, and tools for generating real-time coupon/advertisement data-files that may be housed in a one-stop database or repository of data-files and can easily be searched for/retrieved by data-file users at any time using, for example, a keyword, subject, and gee-location. In addition, the present invention can allow data-file creators to access their already published data-files using the system's secure online portal. This access can take place in real-time such that editing of data-file content may be exercised, if so desired by the creator. Moreover, all edits can be ingested by the system, re-published, and re-disseminated in real-time. Thus, the present invention offers unique inception to end of life-cycle features which may be controlled by the data-file creator at a significantly reduced costs and with much added flexibility. Furthermore, the present invention is a system that allows creators of data-files to develop need-specific real-time advertisements, coupons, offers, sales, announcements and/or any other data-files desired such as garage sale announcements without online intermediaries or other third-party involvement, such as sales persons or marketing teams; once again resulting in the reduction of overall expenses while offering merchants a unique way to create buzz, anticipation, and excitement on part of the consumers. For example, a restaurant owner can create unique offers and discount data-files for breakfast, lunch, dinner and in-between times based upon the business activity of that day, including offers created for only a specific time of day of their choosing. These unique data-files may be disseminated to customers and data-file users in real time thus creating an ongoing anticipation, excitement and buzz for that merchant's services and product offerings.

In one aspect of the present invention, an online advertisement offer can be created by any merchant using an online form; upon activation, the online advertisement offer may be published in real-time directly to the present system's database. Real-time publication of data-files provides the data-file creator a distinct value, by providing continuous and ongoing customer's interest and, for example, obtaining purchases of their products/services within hours and, perhaps in many cases, within minutes of publication of the data-file. This value for data-file creators may be quantified monetarily in increased sales and profits; and for the data-file user in increased savings. A data-file user or customer may then search the one-stop database to find the coupon(s) and advertisement offer(s) of interest; the data-file user customer may search by subject matter, keyword, zip code, business (or merchant or creator of data-files) name, business type, product/service type, and/or geographic location. A data-file user or customer may then act upon the recently found online advertisement offer by printing the offer, or multiple offers directly, by providing the electronic QR scanning code to the merchant (if the merchant is setup to accept QR codes), and/or by presenting a digital copy of the coupon to the merchant. In addition, the data-file user customer(s) may share the online coupon with other persons, such as friend(s) and/or family, via a social media connection means for posting the online advertisements generated through the herein disclosed systems and/or methods.

The ability for data-file users to initiate and direct searches for coupons or other data-files based upon criteria of businesses, such as geographic location or a type of product/service offered by the business for example, is revolutionary in many ways. Generally, currently available digital advertising and marketing platforms rely on the business/merchant locating and filtering for customers, meaning that the direction of marketing outreach is from the merchant to the customer. This is problematic for many reasons including the fact that businesses bear the cost of locating and filtering customers via email, using invasive technology such as cookies and digital tracking of the data user, or paying third-part mediums like social media giants a huge marketing budget to locate customers for them. It is also problematic for the data-users and customers as they must relinquish anonymity through at minimum a disclosure of their geographic location and in many instances may also pay an access fee to third party platforms to take advantage of coupons and offers. But the herein disclosed systems and methods provide a digital advertising and marketing platform that allows data-file users and customers to initially locate and filter businesses resulting in cost savings for both data-file creators and users. In other words, the direction of outreach is activated by data-file user and consumers to locate products and services offered by merchants. Thus, customers or data-file users may be offered products and/or services without having to disclose their geographic location—instead, the data-file user would search using business criteria such as subject matter, keyword, zip code, business (or merchant or creator of data-files) name, business type, product/service type, and/or geographic location. The herein disclosed systems and methods also provide another advantage. Digital security and privacy issues are a growing concern for digital users, especially as the internet and new technologies have made personal information more accessible and easier to collect, access and re-purpose or manipulate. The right to privacy should not be forgone simply because we are in a ‘digital age’. All data users deserve options that allow them the privacy, security, and anonymity when using digital information. The present invention does not require deployment of any tracking cookies or monitoring of any data-file user customer's search history and browsing habits as it leaves it to data-file users to initiates the search on many different criteria without a need to disclose any personal information. The present invention also maintains algorithms for monitoring data-file creators' word and phrase usage. The system stops and prevents the data-file creator from being able to publish and disseminate if they do not correct/change the flagged terminology that may be considered bad and uncivil and ensuring that the platform is children-friendly and not a safety hazard in any way.

Furthermore, a data-file user customer's printing actions, scanning actions, and social media sharing actions may be tracked and managed by the data-file creator to monitor the circulation, distribution, and expiration of the merchant's data-file and online advertisements. The coupon (data-file) tracking system can be used to generate well-qualified sales leads, in addition to assisting the merchant(s) in identifying the advertisement offers that have an overall higher efficacy and customer penetration. It is important to note that the present invention's data-file tracking algorithm performs this operation while not interfering with the integrity of the data-file user's personal privacy at all times. All these features can be implemented as an intricate part of an advertising and marketing scheme based upon the herein provided systems and methods. The present invention offers this dynamic functionality in an environment conducive to both large retailers and smaller-scale creators of data-files, at very low cost and effort on their part.

Thus, the present systems and methods provide for creation publication, and dissemination of data-files from its inception to end of life-cycle, features all controlled by the data-file creator-in real-time. The present invention allows for pre-set, finite lifetimes of the data-files to be determined by the data-file creator. The preset, finite life-cycle is defined as when the data-file may disappear from the Internet permanently, never to be found again. These unique features described herein allows the data-file creator the right to be forgotten as the data-file may be removed from the published digital web. The right to be forgotten is an emerging legal concept allowing individuals control over their online identities by demanding that internet search engines remove certain results; the concept is grounded in notions of privacy and data protection but also relates to intellectual property, reputation and rights of publicity. Thus the herein disclosed methodology can be used as a tool to protect the right to be forgotten. These lifetimes can be decided by the data-file creator and merchant and can be either a preset, finite time-period or the maximum number of redemptions of any given data-file or the data-file creator can remove the data-file from the database in real-time. The present invention can utilize algorithms to monitor time periods, as well as a number or quantity of redemptions that have taken place for any given data-file—and the system can make this information available to the data-file creator in real-time. For example, if so desired the data-file creator can enter a physical address location, anywhere in the world, into the present invention's system and the published data-file will include a dynamic geo-map that all data-file users can view. This dynamic feature allows for customers or other data-file users to quickly arrive at their intended destination saving, both, time and money for the data-file user & creator. The present invention includes coherent organization of the data-files within a structured comprehensive database, and searchability of the structured comprehensive database through data-file user directed searches of business-related criteria such as location, keyword, zip code, business name, business type, and/or product or service offered.

The present invention provides merchants or other creators of data-files with an inexpensive method, system, and/or tool to quickly create advertisement offers that can penetrate larger market segments of potential consumers. Furthermore, the present invention improves upon existing coupon services by providing merchants with the flexibility to directly create and publish electronic advertisement offer data-files in real-time and on an on-demand basis. In addition, the present invention does not require merchants to pay large sums of marketing expenses to advertisement agencies, sales person(s), or to other third-party intermediaries. As such, merchants and small business owners can manage their own coupons and advertisement offers in real-time and on an as-needed basis, thus providing more value and extended convenience. The present invention is a systematic tool that is do-it-yourself (DIY), easy to use, and inexpensive; efficiently disseminating advertisement offers to larger consumer market segments.

Once an advertisement offer data-file is created by a merchant, a method is provided in the system for distributing the digital e-coupons via an easily accessible networked database that data-file user customers can access at any time from any computing device. The method includes the steps of receiving the digital coupons, storing them in a central database, and allowing access of that database to data-file user consumers. In addition, the system and method also include offering data-file users consumers the means to search the coupon database, find coupons by subject/keyword/geo-location, print the coupon(s), and/or redeem the coupon(s) electronically.

The system offers features important to the management of electronic coupon data-files and helps minimize the risk of fraud, scams, and misuse that are generally associated with the current coupon industry. The system also allows the merchant(s) to select and impose an expiration date at the time of advertisement offer/coupon inception. The system is formulated to take any expired coupon(s) out of public circulation on that pre-selected date. The present invention's system also allows the merchant(s) to limit the circulation of any coupon(s) to a specific number; again, selected by the merchant at the time of coupon inception. This allows the merchant(s) to govern over how many coupons the business can handle in any given time period. Once that ceiling is reached, the system will automatically remove the coupon(s) from the system database and from public circulation.

The coupon(s) created by merchants using the present invention's system can be printed or scanned multiple times over the course of its active status. The present invention's system also allows data-file user customers to print the coupon(s) on a single page via a single printing command. For example, multiple coupon offers (or coupons) may be printed in tandem to create a coupon-book of sorts including multiple coupons. On the other hand, coupons can also be redeemed electronically if the merchant wishes to use this method, and if the data-file user consumer decides that he or she wants to pursue this method.

Furthermore, the present invention's system allows for merchants to gather email addresses and contact information of data-file user consumers who view particular advertisement offers. This provision in the present invention's system allows merchants the ability to easily identify potential consumers and generate viable, valuable, and well-qualified sales leads for future purposes; a process that would otherwise require significant time and assets.

The present invention's system allows data-file user consumers to check for new offers and deals on an ongoing basis and at any given time. These data-file user consumers can easily detect offers in any given geographic location without saving newspaper ads, magazine clippings, and coupon card mailers. In addition, these data-file user consumers do not have to remember deals from their memory that they may have seen or heard about through media outlets such as television advertisements, billboards, and the radio. Data-file users consumers may look for and search through the present invention's database system for all relevant products and services, with both ease and convenience.

Another embodiment of the present invention's system is the ability of the data-file user consumer(s) to disseminate any given advertisement offer that they find in the database to other individuals whom they believe might interested in the product and/or service. This dissemination can come in the form of a tweet, email, and/or other social media apparatus ultimately providing merchants with an overall larger customer base.

### BRIEF DESCRIPTION OF THE SEVERAL VIEWS OF THE DRAWING

FIG. 1 illustrates a general overview of the herein disclosed system for creating on-demand real-time data-files with preset cycles and lead generation, in accordance with the present invention;

FIG. 2 includes a flow diagram illustrating an exemplary embodiment of a method for creating on-demand real-time data-files, in accordance with the present invention;

FIG. 3A illustrates an exemplary online advertisement which has been generated through the herein disclosed method for creating on-demand real-time data-files, in accordance with the present invention;

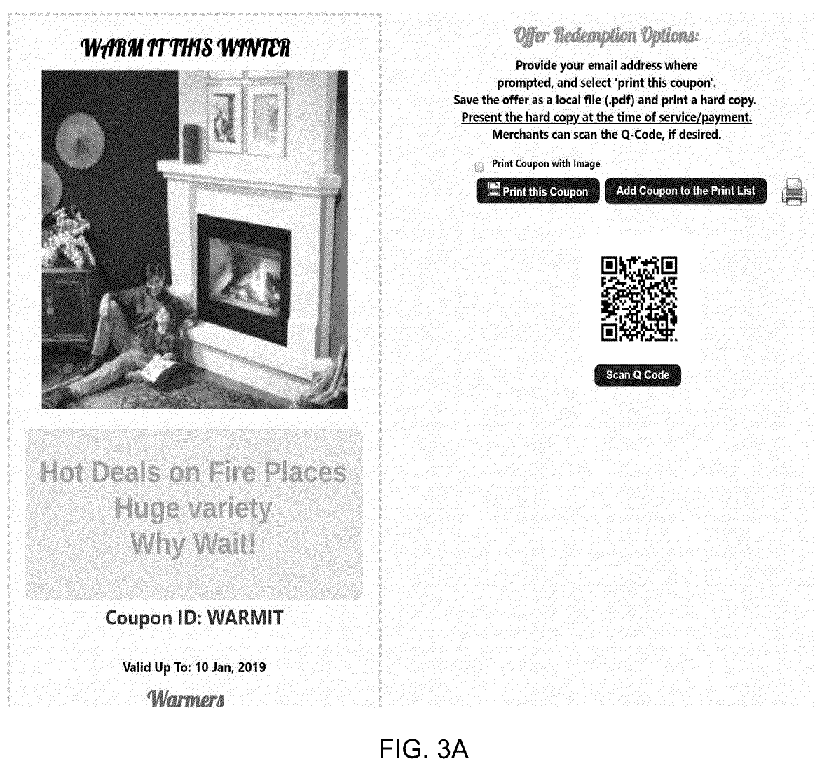

FIG. 3B illustrates an exemplary embodiment of a search function webpage presenting a list of online advertisements to an data-file user customer, in accordance with the present invention;

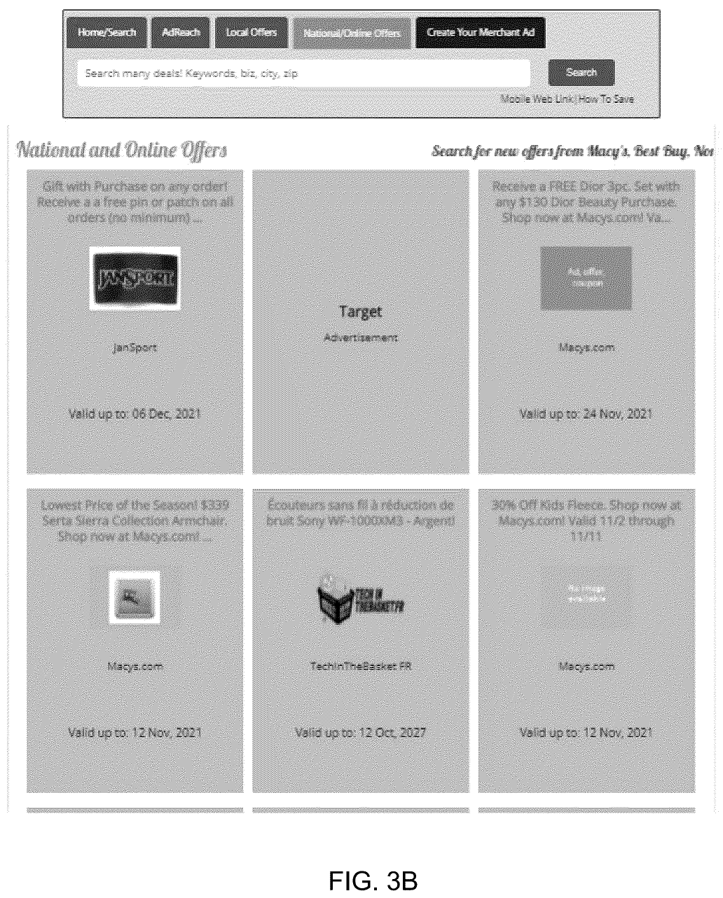

FIG. 4 includes a flow diagram illustrating an exemplary embodiment of a method for creating an online advertisement having limited coupon circulation as determined by a merchant, in accordance with the present invention;

FIG. 5 includes a flow diagram illustrating an exemplary embodiment of a method for creating an online advertisement facilitating lead generation for a merchant, in accordance with the present invention;

FIG. 6 includes a flow diagram illustrating an exemplary embodiment of a method for creating an online advertisement facilitating tracking of an data-file user customer redeeming the online advertisement, in accordance with the present invention; and

FIG. 7 illustrates an exemplary embodiment of a digital advertisement creation form for receiving one or more items of digital advertisement information from a merchant, in accordance with the present invention.

### DETAILED DESCRIPTION OF THE INVENTION

For the purposes of this invention a merchant is any person, business, company, or entity involved in trade, service, or commerce. A merchant ad represents, coupons, advertisements, special offers, promotions, vouchers, and similar offerings from a merchant to a user that may be used to generate interest and/or a sale of that merchant's services and products.

It will be apparent to those skilled in the art that additional uses beyond merchants may advantageously utilize the systems and methods disclosed herein and all such uses are intended to be included herein. A user of the systems or methods herein disclosed may be referred to as a creator, as a creator of data-files, or as a creator of a data-file. The term creator is intended to include all such possible users, including merchants, publishers, journalists, bloggers, or any other person or entity interested in creating a publishable data-file. For example, a creator may be a general citizen who may be having or planning a garage sale who wishes to post data and locations for the garage sale via the herein discloses systems and methods. In another example, a creator may be a general citizen who may be planning to sell an item.

Throughout this specification the herein disclosed system and methods will mostly be referred to as a system or methods for creating online advertisements. The phrase online advertisements is intended to include coupons and other business promotions. Those skilled in the art will recognize that the disclosed systems and methods may be utilized advantageously to create other types of data-files (or online data-files) that are generally associated with marketing a business entity, and all such uses are intended to be included herein. Therefore, at times the herein disclosed invention may be referred to as system and method for creating a data-file for a merchant having a business and presenting the data-file to one or more data-file user customers in a data-file user customer online database. The phrase data-file user customer is intended to refer to a person (or group of persons) using the database to search or find online advertisements (or data-files).

Alternative embodiments of the herein disclosed systems and methods may include a journalist wishing to create a data-file to publish news and/or written information or data concerning current events. In another alternative embodiment, a user may wish to create a data-file including dialog from a conversation (written or verbal).

An exemplary embodiment of the herein disclosed method for creating an online advertisement for a merchant or other creator of a data-file having a business and presenting the online advertisement to one or more data-file user customers in an online advertisement database may comprise the steps of: receiving account set up information from the merchant or creator of a data-file; receiving a life cycle selection from the merchant or creator of a data-file; presenting a web form to the merchant or creator of a data-file, wherein the web form includes one or more online advertisement fields for receiving online advertisement-related information from the merchant or creator of a data-file; automatically generating an auto-generated online advertisement code; presenting the auto-generated online advertisement to the merchant or creator of a data-file; receiving a determination of whether to utilize the auto-generated online advertisement code; receiving an online advertisement circulation quantity from the merchant or creator of a data-file, wherein the online advertisement quantity is a quantity of online advertisements which may be utilized by the one or more data-file user customers before the online advertisement is removed from the data-file user customer online database; receiving a final approval from the merchant or creator of a data-file; activating the online advertisement by storing the online advertisement in the data-file user customer online database; and presenting the online advertisement to the one or more data-file user customers by displaying the online advertisement on a display screen to the one or more data-file user customers.

Alternative embodiments of the herein disclosed methods may further include steps for generating leads for the merchant or creator of a data-file and displaying those leads to the merchant or creator of a data-file, as well as steps for receiving search criteria from the one or more data-file user customers and utilizing the search criteria to determine a subset of online advertisements to present to the data-file user customers.

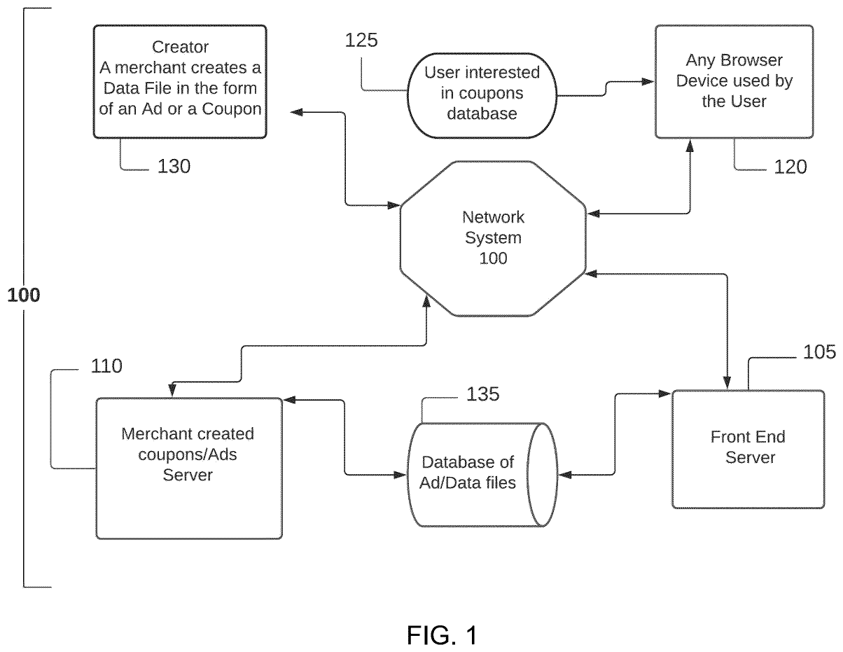

FIG. 1 is a system (and associated methods) for serving merchant created (or alternative creator-created) coupons and advertisements straight to users. Users are referred to herein as data-file user customers to distinguish these data-file user customers from the creators of data-files who may use the system to create coupons, online advertisements, and/or other data-files associated with marketing the creator of data-files' business. FIG. 1 illustrates an exemplary embodiment of system 100 for creating, publishing and disseminating creator of data-files ads, both in print and electronic directly by creators of data-files and business owners or their representatives without an intermediary such as the marketing and sales team. The system 100 includes a front-end server 105 for communicating with data-file user customers, a back-end server 110 (which may be referred to as data-file user customer online database), and a creator of data-files created/stored database 135. The various components of the system 100 may reside on a single computer or be distributed among several computers interconnected by a communication network.

The front-end server 105, back-end creator of data-files server 110, may correspond to an Intel®, AMD®, or PowerPC® based computer or a different computer. The front-end server 105, coupon server 110, and creator of data-files input device 130, and user browser device 105 may include an operating system, such as a Microsoft® Windows®, LINUX™, or other Unix® based operating system. The front-end server 105, coupon server 110, and advertisement database 135 may be configured to communicate with other computers via an interface, such as a network interface.

The front-end server 105 may include code, logic, and/or other circuitry that enables the reception of a request to serve a web page to a browser device 120, and to communicate the web page to a browser operating on the browser device 120. The browser device 120 may correspond to a computer, smartphone, or any other device associated with an internet address and capable of displaying a web page. The web page is a data-file including hypertext markup language (HTML) code or other information to cause the user's browser to produce a particular display on the browser device 120 operating the browser. For example, the web page communicated may include information, such as a web form which may be used by creators of data-files 130 to input creator of data-files related information about their product. The creators of data-files may be created anytime, anywhere and published in real time by creators of data-files 130.

The web page communicated may also include a search box that end-user customer 125 can use to input keywords, business name, city, zip code, or other words to search the searchable database of creator of data-files ads, offers and coupons. The creators of data-files may include local, national, or international companies and their offers that are created by creators of data-files 130 located anywhere in the country or any other country.

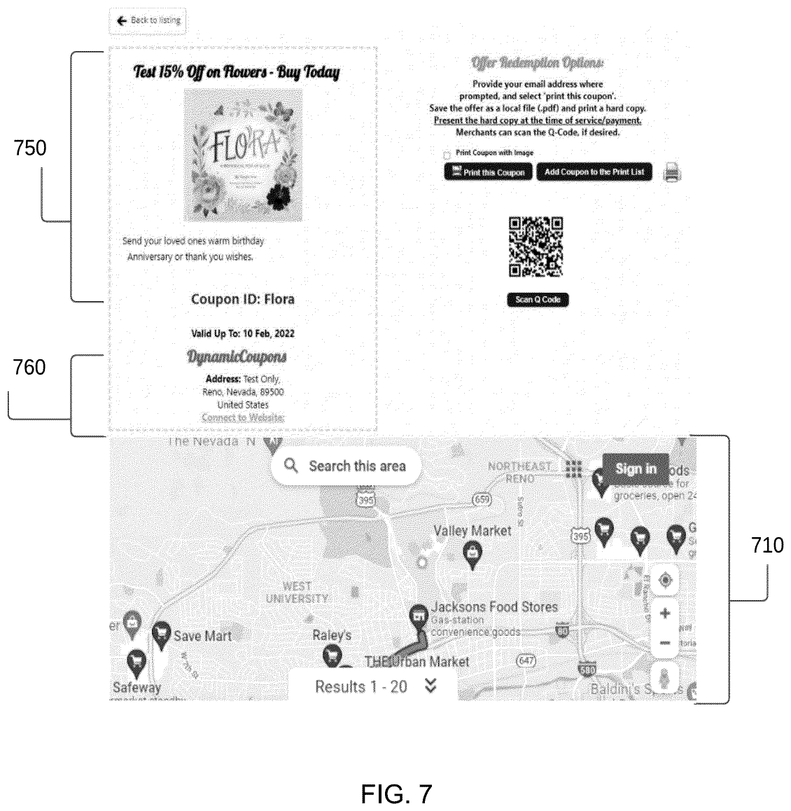

In an exemplary embodiment, front-end server 105 is configured to provide a web form 200 (which may be referred to as a creator of data-files input receiving page, an exemplary embodiment of which is illustrated in FIG. 7) that enables a creator of data-files to create an online advertisement from scratch by inputting information specific to every input field in a creator of data-files ad. The web page 200 may enable specifying creator of data-files identifying information 760 (such as a business owners name, a business name, and a business website, for example), and creator of data-files geolocation information 710 for the creator of data-files (such as a physical address and a zip code, for example). The web page 200 may also enable uploading the content of the coupon including an image file such as merchant's business logo. For example, the web page may enable uploading an image 750 and/or text of a merchant or products offerings that creator of data-files wants to advertise or even a copy of an actual printed coupon that was not created using the system 100 offered here.

The back end server 110 may include code, logic and/or other circuitry that enables storing advertising and marketing information received from creator of data-files 130 in a coupon database 135. The back-end server 110 may also be configured to retrieve coupons from the coupon database 135. After a search is conducted by the user 125 in a browser operating on the browser using a browser device 120.

The creator of data-files database 135 may include information that defines one or more creators of data-files. For example, data that defines the content of a merchant or creator of data-files, such as pixel data and/or text data, may be stored in the database 135. Data that defines the geographic location of a creator of data-files 130 associated with the creator of data-files, a zip code is also stored in the creator of data-files database 135. For example, the data may include the address of the creator of data-files 130, a closest intersection to the creator of data-files 130, a latitude and longitude of the creator of data-files 130, and/or other information that enables determining the geographic location of the creator of data-files 130.

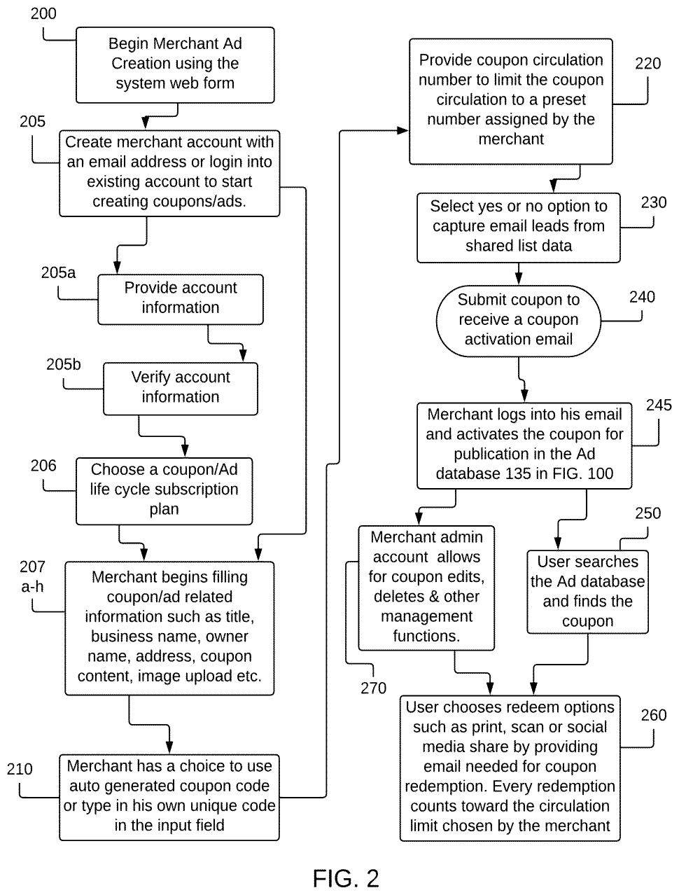

FIG. 2 is flow diagram showing a method associated with the creation of a merchant online advertisement that may be performed by the system 100. At step 200, a web page 200 (an exemplary embodiment of which is illustrated in FIG. 7) for registering by setting up an account to start the process of merchant creation may be communicated to a merchant or creator of data-files. The web page may include fields that allow the creator of data-files to specify a user name and/or password if the creator of data-files has an account with the system 100. Alternatively, an unregistered creator of data-files may receive an indication, via the web page, that a new account is to be created.

If at step 205, a merchant or creator of data-files account does not exist, then at step 205a, the merchant or creator of data-files may provide account information. For example, the merchant may provide an email, user name, and password. The merchant may specify information that describes the merchant's business, such as grocer or mechanic. The merchant may also specify an address associated with the business.

At step 205a, the information provided by the merchant or creator of data-files may be verified. For example, the system 100 may determine if the address actually exists and is registered to the business specified. If the information cannot be verified, the merchant or creator of data-files may be prevented from going any further and may be given an opportunity to provide verifiable information.

If at step 205a, the merchant or creator of data-files has an existing account or the merchant account is verified at step 205b, then the merchant or creator of data-files may proceed to the next step.

At step 206, the creator of data-files chooses from a selection of fee enabled options that leads to posting the coupon or online advertisement for a fixed time, such as 1 day, 1 week, 15 days, 1 month and 3 months or an open date. In an alternative embodiment, this option can be set for a non-fee or free selection. In another alternative embodiment, this option may be presented towards the end of the web-form completion. All coupons may be preset to expire at the end of selected time period chosen by the creator of data-files. The data-files may be taken out of public view or the data-file may be permanently deleted from the internet-connected database. However, the coupons may still be in the ad database in system 100.

At step 207a-h, the information may be received from the creator of data-files through the creator of data-files filling out all the fields necessary for the completion of the coupon. For example, an input field for coupon title may be provided where the creator of data-files may provide enticing offers to customers, for example, “Buy Two, Get Third Sandwich FREE.”

In addition, as indicated in steps 207a-h, some input boxes may ask the creator of data-files to upload the content of the coupon, such as the graphics and/or text that define the coupon, and the restrictions and legal language pertaining to coupon. Yet, other input boxes in system 200 of create a coupon may require creator of data-files to provide business name, address, zip code, country and also the business or product website as part of the coupon. In this way all necessary merchant information, or creator of data-files information, may be received by system 100 and then utilized to create an online advertisement for the merchant.

In another embodiment, an image of a creator of data-files's traditional coupon may be received and combined with features such as limiting circulation count and/or the lead generation option offered in the present invention.

Like a traditional coupon, an online advertisement created by system 100 as described herein offers a creator of data-files the option to create and publish their coupon with unique set of numbers or letters called coupon code. The same feature may be presented (at step 210) where creators of data-files have an option to accept the auto generated coupon code, a barcode, or provide his own text/number combination for merchant created coupon code. This feature may offer protection to merchants or other creators of data-files from fake, fraudulent and scams associated with coupons that coupon providers are always weary of. Also, both the creators of data-files and employees can reduce the mismanagement as the coupon generated using this system as unique coupon codes may help track use of each coupon.

Another issue that may be on minds of merchants or other creators of data-files is the fraud and misuse that is associated with any coupon marketing. The system 100 offered here may have a system-built-in function that allows creators of data-files to limit the circulation of his coupon to a preset number. At step 220, a creator of data-files may provide a coupon circulation count 740, a numerical number that tells the system 100 how many times this specific coupon can be used for redemption. Once the circulation limit number reaches the designated number, the finite life cycle can be defined a complete and the data-file may be taken out from public circulation or the data-file may be permanently deleted from the internet-connected database but may remain in the system under the creator of data-file's admin account (step 270) to reuse it at a later time.

Generating new leads is another constant struggle faced by creators of data-files on an ongoing basis. The system described herein provides for receiving an option from a creator of data-files at step 270 to receive shared emails. Shared emails are the emails collected during the coupon redemption process (step 260) from the one or more data-file user customers. An email may be designated or otherwise shared as an email address; those skilled in the art will recognize that other personal digital designations besides an email address (or email addresses) are used by people, customers, and/or data-file users and all such personal digital designations (such as user names, screennames, codes, player names, handle, etc., for example) are intended to be included herein as being equivalent to an email address. All data-file user customers redeeming an online advertisement may be required to provide an email address before printing, scanning or social media sharing of the coupon to receive the benefits of the offer. Creators of data-files may decide to opt for this feature which may be a fee or a free service. Creators of data-files will be able to download the email list from their admin account as in step 270 and use the list for future marketing and sales.

Upon completing the web form 200 at steps 207a-f, system 100 may ask for and receive a final approval for publication from the merchant or creator of data-files.

An exemplary embodiment of step 245 may be carried out as a merchant or creator of data-files receiving an email requesting the creators of data-files' final approval for coupon activation. For example, an email may be received by the creator of data-files under the email address provided by the creator of data-files at the start of method 200 during the process of account creation. Once activated, the creator of data-file's online advertisement may become part of data-file user customer online database 135 of system 100.

The redeem process as set in step 260 is a system-built-in process whereby a online advertisement data-file user customer may be required to provide an email address as part of indicating interest in, or selecting, the online advertisement. An email input box for receiving the data-file user customer's email address may pop up automatically when the print function, coupon scan function and social media icons are clicked upon by the user. The email provided during this process in step 260 are collected and may be used by the system administrator and the creator of data-files who created the online advertisement.

Furthermore, as in step 270 of method 200, a creator of data-files using a creator of data-files admin account may request an edit to, or deletion of, the creator of data-file's own coupon during any time the coupon is in active status thus making the overall management of a creator of data-file's coupons very dynamic in nature and completely in the creator of data-file's control without a need for an intermediary. In other words, a creator of a data-file may, at any time, remove a previously published data-file from the searchable dynamic database of data-files.

At all steps from 206-260 the content of the coupon may be screened as the content is being composed by the merchant or creator of data-files. For example, text recognition software or a software that denies acceptance of certain text may be utilized to screen the coupon for profanity. In some embodiments, a human reviewer may analyze the coupon to verify that the coupon is suitable for distribution. Upon successful completion of all input fields, the merchant or creator of data-files may be required to activate at step 245 prior to final publication and storage in the system 100 to a coupon database such as the coupon database 135. For example, the steps 206 through 260 may include a rigorous and comprehensive word filter that can flag and/or disallow foul language, wherein the definition of foul language can be predetermined or determined by one or more creators of data-files. In this manner, the herein disclosed systems and methods for creating and organizing on-demand instant real-time data-files with preset life cycles and searchable lead generation can be made completely family friendly and/or can be made to conform to local standards of decency and acceptability.

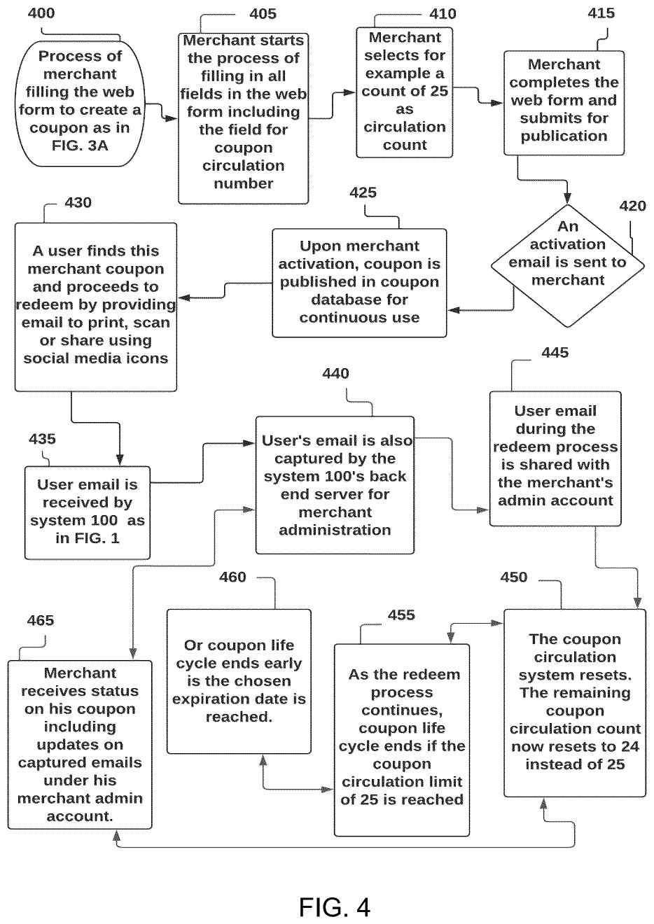

Referring to FIG. 4, step 410 involves receiving from a creator of data-files the number of circulation limit (a circulation quantity) the creator of data-files would like to place on the coupon. The creator of data-files in this example chooses 25. Steps 415-425 indicate the process of coupon publication in the online advertisement database 135 of system 100.

At step 430 an data-file user customers selects a merchant coupon (or a coupon created by a creator of data-files) and proceeds to redeem, by printing the coupon for example. The redeem function as set in this system may present intent of user to print, scan or share the coupon on social media with final action of presenting the coupon to entertain its value at the place of business. As set in this system, the user may accomplish this by providing his email in the pop-up box which may appear at the time of redeem options. As presented in the steps 435-440, data-file user customer email is received by the system and processed by the system 100 whereby one instance of redeem is used against the total coupon circulation and subtracted from 25 (at step 410). For purposes of this example of system 100, now the total coupon circulation limit starts anew with 24 (at step 450) and back to process in step 425. The system lets this function repeats itself until all 25 coupons get redeemed. At that point the coupon is taken out of public circulation as in step 455 with creators of data-files having access to the coupon and emails from his admin account.

In an exemplary embodiment of the herein disclosed systems and methods, the creator of the data-file or files is able to instantly monitor the number of data-files that are still available to data-file users. In other words, a merchant may be able to view, determine, or otherwise have access to a real-time quantity of coupons in circulation. Such a real-time circulation quantity (or available data-file quantity) may be kept up-to-date through decreasing the quantity each time an data-file user has redeemed a data-file or coupon.

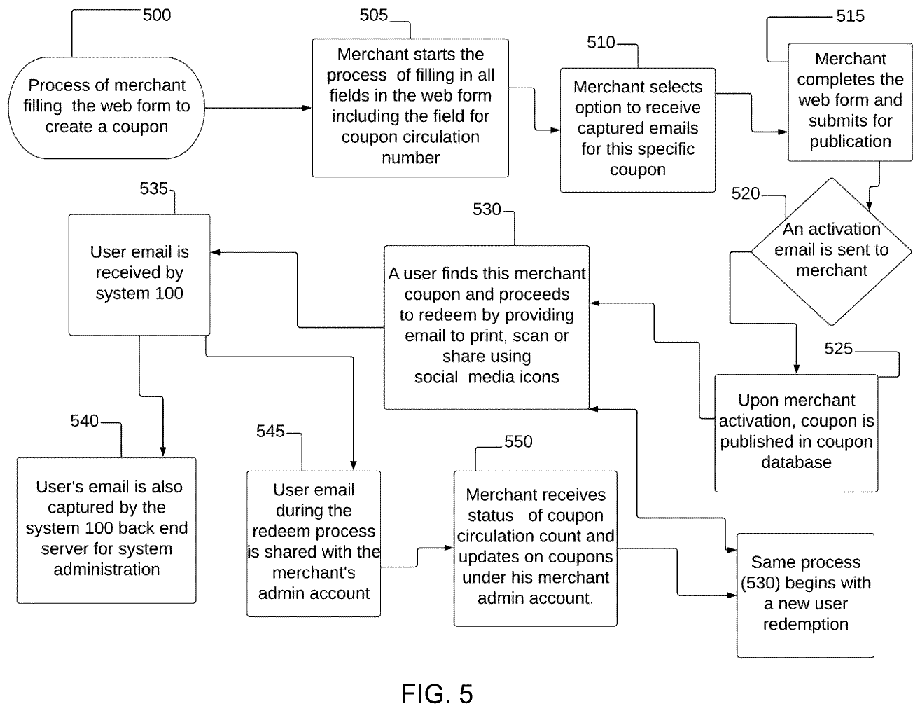

Referring to FIG. 5, a flow diagram illustrates an exemplary embodiment of a method for creating an online advertisement facilitating lead generation. A choice of whether or not to receive shared email data is presented to a creator of data-files at step 510; and the creator of data-file's choice is received by the system.

In step 530, an data-file user customer may select a merchant coupon (or coupon created by a creator of data-files) and proceeds to redeem the coupon. The redeem function as set in this system may present intent of the data-file user customer to print, scan or share the coupon on social media with a final action of presenting the coupon to entertain its value at the place of business. For example, the user may accomplish this by providing his email in the pop-up box which may appear at the time of redeem options. As presented in steps 535-540, an data-file user customers email is received by the system and processed by the system 100 and collected in data form. Further, data-file user customers email data may be stored in the system 100 and shared with the creator of data-files for a fee or free to be used as future lead generation (at step 550).

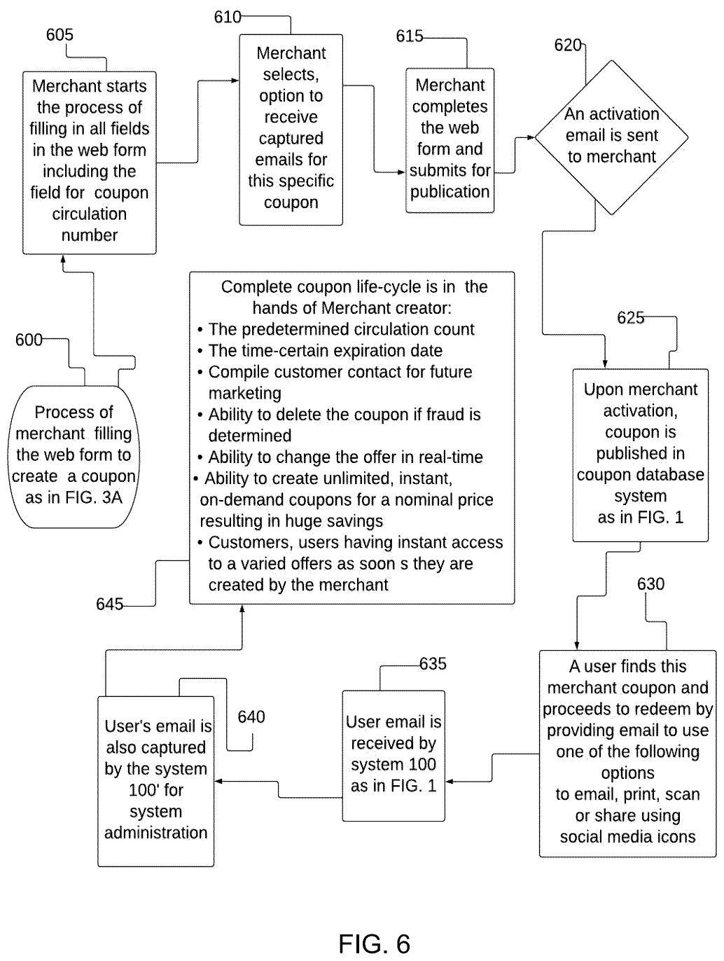

FIG. 6 is a flow diagram showing a group of operations that may be performed by the system 100 when users redeem a coupon.

The redeem function as set in this system (step 630) may be defined and presented as an intent of user to print, scan or share the coupon on social media with final action of presenting the coupon to entertain its value at the place of business. The redeem function may offer creators of data-files control over the management of their coupons as creators of data-files may be able to check the circulation of their coupons at every life-cycle stage via a creator of data-files admin account (at step 645).

The following are four (4) examples of methods that may be utilized to redeem digital advertisements created via the herein disclosed methods:

1) An data-file user customer may bring up the coupon on their phone, iPads and laptops and show the existence of e-coupon to the cashier to receive the said coupon's benefit at the creator of data-file's location.

2) An data-file user customer may print the coupon and present it at the time of checkout at the creator of data-file's establishment. Each printed copy may also have the coupon's QR-code or the barcode which may be scanned by the business establishment at the time of checkout or point-of-sale. Multiple coupons (or coupon offers or data-files) may be printed in tandem (or simultaneously) to form a product much like a coupon-book.

3) If a merchant or other creator of data-files is a small business owner, the merchant may not be equipped with scanning technology to redeem electronic coupons. This e-coupon system may provide an option where the customer using the e-coupon is asked to bring up the e-coupon on his/her mobile device at the time of checkout. The customer at that time may be asked to provide and send his email in the box provided as part of the e-coupon. This email may be received by the business owner who has placed an e-coupon on the said site. The customers email and the check-out receipt at the point-of-sale purpose is to help business owner reconcile the sales associated with e-coupon use.

4) Each e-coupon created via the herein disclosed system and methods may automatically generates a QR-code or a bar code. Creators of data-files equipped with the QR-code scanner at their establishment can help customers redeem the e-coupon at the time of checkout or point-of-sale right from their mobile devices.

In an additional embodiment of the present invention, additional steps or features may be provided that facilitate a website owner becoming a publisher of the types of digital coupons or data-files that may be created using the methodology described herein. For example, a website owner may sign up or register with the herein disclosed systems or methods as a publisher, after which the publisher will be granted a unique publisher code that has been automatically generated. The publisher may then paste (or post) this unique publisher code into the publisher's website, creating a picture with a hyperlink. Third parties (such as web traffic visiting the publisher's website) who view the unique publisher's code (or the picture having a hyperlink) and have a desire to advertise on the publisher's website may click or select the hyperlink and be brought directly to a website for creating and organizing digital coupons so that this third party may sign up as an advertiser for the publisher's website through the website for creating and organizing digital coupons. The third party, who now may be referred to as an advertiser, may then select or choose a kind, size, and/or shape of advertisement (digital coupon or data-file) the advertiser wishes to have displayed on the publisher's website, and where the advertiser wishes to direct data-file users with the advertisement (digital coupon or data-file), such as a website selling a product, for example. Once parameters of the advertisement (digital coupon or data-file) have been selected by the advertiser and associated fees have been paid, another unique advertisement code is created and sent to, or shared with, both the advertiser and the publisher. The publisher can then use the unique advertisement code to essentially publish the advertisement. Revenue generated from the fees associated with advertisers advertising and marketing on publishers' websites can be split between the publishers and the operators of the systems and methods for creating and organizing on-demand instant real-time data-files with present life cycles and searchable lead generation. The publisher may be able to request the publisher's share of revenue through a request for withdrawal of funds.

Creators of data-files may be able to choose from subscription packages during the process of creating and organizing data-files. For example, a single creator or data-files may be able to sign up for a package (or package deal, or subscription deal) that allows for creation of ten (10) digital coupon offers over a predefined time period such as the next three months. At the end of such a predefined or finite time period, the data-file may be permanently deleted from the internet-connected database. Alternatively, the creator of data-files may choose to participate in a grouped offer of a plurality of coupons offered by differing creators of data-files that share common characteristics. For example, a group of digital coupon offers for leisure activities, for kitchen and dining offers, for hotel/motel rooms, for going-out-of-business sales, etc.

Accordingly, the method and system may be realized in hardware, software, or a combination of hardware and software. The method and system may be realized in a centralized fashion in at least one computer system or in a distributed fashion where different elements are spread across several interconnected and communicatively coupled computer systems. Any kind of computer system or other apparatus adapted for carrying out the methods described herein may be suitable. A typical combination of hardware and software may include a general-purpose computer system with a computer program or other machine-readable instructions that, when being loaded and executed, controls the computer system such that it carries out the methods described herein.

The method and system may also or alternatively be embedded in a computer program product which includes all the features enabling the implementation of the operations described herein and which, when loaded in a computer system, is able to carry out these operations. Computer program in the present context means any expression, in any language, code or notation, of a set of instructions intended to cause a system having an information processing capability to perform a particular function, either directly or after either or both of the following: a) conversion to another language, code or notation; b) reproduction in a different material form.

As shown above, the system and methods disclosed herein enable serving localized coupons. For example, an exemplary embodiment of the system is configured to receive data that defines a coupon from a merchant or other creator of data-files and to determine a geographic location of the merchant or creator of data-files. In this exemplary embodiment, the system is also configured to receive a request to serve a coupon from a browser operated by a user and to determine a geographic location associated with the user. Continuing with this exemplary embodiment, the system may then communicate the coupon to the browser if the geographic location associated with the user matches the geographic location of the merchant or other creator of data-files.

It should be apparent that the examples discussed above are only presented as examples. The various user-accessible menus, buttons, and interfaces are only one way to accomplish the more generally described systems, methods, apparatuses, and computer programs. For example, where certain features or user options are described as buttons or input fields, it may be apparent to those skilled in the art that the same function can be accomplished by using radio buttons, drop-down menus, or check-box-type options instead. All such available possibilities are intended to be covered by this specification.

It should be noted that where this specification describes a system for accomplishing an online advertisement-related task, it is intended to cover related methods of accomplishing the online advertisement-related task, related apparatuses for accomplishing the online advertisement-related task, and related computer programs for accomplishing the online advertisement-related task. For example, an apparatus for accomplishing the online advertisement-related task would be comprised of a central processing unit (CPU) containing the code for the carrying out the online advertisement-related tasks and capable of processing user-input options, one or more input devices such as a keyboard and mouse, and a computer screen.

While the present invention has been illustrated and described herein in terms of a preferred embodiment and several alternatives, it is to be understood that the systems and methods described herein can have a multitude of additional uses and applications. Accordingly, the invention should not be limited to just the particular description and various drawing figures contained in this specification that merely illustrate a preferred embodiment and application of the principles of the invention.

What is claimed is:

1. A method for creating, publishing, and disseminating a data-file in real time, wherein the data-file has a finite life cycle and is stored in an internet-connected database that is searchable by one or more end users and by a creator of the data-file, comprising the steps of:
receiving one or more data-file criteria from the creator of the data-file;
creating the data-file based upon the one or more data-file criteria; and
organizing the data-file into the internet-connected database, wherein the internet-connected database is searchable by the one or more end users and by the creator of the data-file based upon the one or more data-file criteria.

2. The method for creating, publishing, and disseminating a data-file in real time, wherein the data-file has a finite life cycle and is stored in an internet-connected database that is searchable by one or more end users and by a creator of the data-file as recited in claim 1, further comprising the step of permanently deleting the data-file from the internet-connected database at an end of the finite life cycle.

3. The method for creating, publishing, and disseminating a data-file in real time, wherein the data-file has a finite life cycle and is stored in an internet-connected database that is searchable by one or more end users and by a creator of the data-file as recited in claim 2, wherein the step of permanently deleting the data-file includes the step of ensuring that the data-file is deleted from an internet in a manner that ensures that the data-file will never be found again in accordance with right to be forgotten standards.

4. The method for creating, publishing, and disseminating a data-file in real time, wherein the data-file has a finite life cycle and is stored in an internet-connected database that is searchable by one or more end users and by a creator of the data-file as recited in claim 2, wherein the end of the finite life cycle is established by reaching a circulation limit.

5. The method for creating, publishing, and disseminating a data-file in real time, wherein the data-file has a finite life cycle and is stored in an internet-connected database that is searchable by one or more end users and by a creator of the data-file as recited in claim 2, wherein the end of the finite life cycle is established by a conclusion to a predefined time period.

6. The method for creating, publishing, and disseminating a data-file in real time, wherein the data-file has a finite life cycle and is stored in an internet-connected database that is searchable by one or more end users and by a creator of the data-file as recited in claim 1, wherein the method does not include a step for receiving one or more items of personally identifying information from the one or more end users.

7. The method for creating, publishing, and disseminating a data-file in real time, wherein the data-file has a finite life cycle and is stored in an internet-connected database that is searchable by one or more end users and by a creator of the data-file as recited in claim 1, further comprising the steps of:
determining whether the one or more data-file criteria received from the creator of the data-file includes profanity; and
flagging the profanity to indicate to the creator of the data-file that the one or more data-file criteria must be edited.

8. The method for creating, publishing, and disseminating a data-file in real time, wherein the data-file has a finite life cycle and is stored in an internet-connected database that is searchable by one or more end users and by a creator of the data-file as recited in claim 1, wherein the one or more data-file criteria include a location, a keyword, a zip code, a business name, a business type, and a product or service offered.

9. The method for creating, publishing, and disseminating a data-file in real time, wherein the data-file has a finite life cycle and is stored in an internet-connected database that is searchable by one or more end users and by a creator of the data-file as recited in claim 1, wherein the one or more data-file criteria includes criteria selected from a group consisting of a location, a keyword, a zip code, a business name, a business type, a product offered, or service offered.

10. The method for creating, publishing, and disseminating a data-file in real time, wherein the data-file has a finite life cycle and is stored in an internet-connected database that is searchable by one or more end users and by a creator of the data-file as recited in claim 1, wherein there is no requirement that a third party act as middleman to determine suitableness of the data-file for organization in the internet-connected database.

11. The method for creating, publishing, and disseminating a data-file in real time, wherein the data-file has a finite life cycle and is stored in an internet-connected database that is searchable by one or more end users and by a creator of the data-file as recited in claim 1, wherein the data-file is printable.

12. The method for creating, publishing, and disseminating a data-file in real time, wherein the data-file has a finite life cycle and is stored in an internet-connected database that is searchable by one or more end users and by a creator of the data-file as recited in claim 1, further comprising the step of:
tracking a circulation of the data-file to determine a quantity of data-files that are presently available for use by the one or more end users.

13. The method for creating, publishing, and disseminating a data-file in real time, wherein the data-file has a finite life cycle and is stored in an internet-connected database that is searchable by one or more end users and by a creator of the data-file as recited in claim 12, further comprising the steps of:
decreasing the quantity of data-files that are presently available for use by the one or more end users at each instance of the data-file being redeemed; and
displaying to the creator of the data-file the quantity of data-files that are presently available for use by the one or more end users.

14. The method for creating, publishing, and disseminating a data-file in real time, wherein the data-file has a finite life cycle and is stored in an internet-connected database that is searchable by one or more end users and by a creator of the data-file as recited in claim 1:
receiving a data-file circulation quantity from the creator of the data-file;
determining when the data-file circulation quantity has been reached; and
removing the data-file from the internet-connected database when the data-file circulation quantity has been reached.

15. The method for creating, publishing, and disseminating a data-file in real time, wherein the data-file has a finite life cycle and is stored in an internet-connected database that is searchable by one or more end users and by a creator of the data-file as recited in claim 1, further comprising the step of redeeming the data-file for the creator of the data-file.

16. The method for creating, publishing, and disseminating a data-file in real time, wherein the data-file has a finite life cycle and is stored in an internet-connected database that is searchable by one or more end users and by a creator of the data-file as recited in claim 15, wherein the step of redeeming the data-file for the creator of the data-file includes the steps of:
receiving a print data-file determination from the one or more end users, wherein the print data-file determination is an indication of whether to print the data-file;
receiving a scan determination from the one or more end users, wherein the scan determination is an indication of whether to display the data-file on a display screen for presentation to the creator of the data-file; and
receiving a social media share determination from the one or more end users, wherein the social media share determination is an indication of whether to share the data-file on social media.

17. The method for creating, publishing, and disseminating a data-file in real time, wherein the data-file has a finite life cycle and is stored in an internet-connected database that is searchable by one or more end users and by a creator of the data-file as recited in claim 1, further comprising the step of:
receiving a publisher sign-up from a publisher, wherein the publisher operates a website having advertising space;
generating a unique publisher code and displaying this unique publisher code to the publisher;
receiving an advertiser sign-up from an advertiser, wherein the advertiser is a third party desiring to advertise at the website having advertising space and wherein the advertiser sign-up includes a platform fee;
generating a unique advertisement code and displaying the unique advertisement code to both the publisher and the advertiser; and
sending a portion of the platform fee to the publisher based upon a request by the publisher.

18. A system for creating, publishing, and disseminating a data-file in real time, wherein the data-file has a finite life cycle and is stored in an internet-connected database that is searchable by one or more end users and by a creator of the data-file, comprising:
a front-end server for communicating with the one or more end users;
a back-end server for communicating with the creator of the data-file;
the internet-connected database for storing the data-file;
a browser device for receiving one or more data-file search criteria from the one or more end users, communicating with the internet-connected database, and displaying the data-file to the one or more end users;
wherein the back-end server carries out the steps of receiving one or more data-file criteria from the creator of the data-file, creating the data-file based upon the one or more data-file criteria, and organizing the data-file into the internet-connected database; and
wherein the font-end server carries out the steps of receiving the one or more data-file search criteria from the one or more end users and displaying a set of qualifying data-files to the one or more end users based upon the one or more data-file search criteria.

19. A method for creating, publishing, and disseminating a data-file in real time, wherein the data-file has a finite life cycle and is stored in an internet-connected database that is searchable by one or more end users and by a creator of the data-file, comprising the steps of:
receiving account set up information from the creator of the data-file;
receiving a life cycle selection from the creator of the data-file;
presenting a web form to the creator of the data-file, wherein the web form includes one or more data-file fields for receiving data-file-related information from the creator of the data-file;
automatically generating an auto-generated data-file code;
displaying the auto-generated data-file code to the creator of the data-file;
receiving a determination of whether to utilize the auto-generated data-file from the creator of the data-file;
receiving a unique code from the creator of the data-file, wherein the unique code is equivalent to the auto-generated data-file code if the determination to utilize the auto-generated data-file code has been received from the creator of the data-file;
receiving a data-file circulation quantity from the creator of the data-file, wherein the data-file circulation quantity is a quantity of data-files which may be utilized by the one or more end users before the data-file is removed from the internet-connected database;
receiving a final approval from the creator of the data-file;
activating the data-file by storing and organizing the data-file in the internet-connected database; and
presenting the data-file to the one or more end users by displaying the data-file on a display screen accessible to the one or more end users.

20. The method for creating, publishing, and disseminating a data-file in real time, wherein the data-file has a finite life cycle and is stored in an internet-connected database that is searchable by one or more end users and by a creator of the data-file as recited in claim 19, wherein the data-file-related information includes one or more criteria selected from a group consisting of a location, a keyword, a zip code, a business name, a business type, a product offered, or service offered.

21. The method for creating, publishing, and disseminating a data-file in real time, wherein the data-file has a finite life cycle and is stored in an internet-connected database that is searchable by one or more end users and by a creator of the data-file as recited in claim 19, wherein the auto-generated data-file code is a bar code.

22. The method for creating, publishing, and disseminating a data-file in real time, wherein the data-file has a finite life cycle and is stored in an internet-connected database that is searchable by one or more end users and by a creator of the data-file as recited in claim 19, wherein the auto-generated data-file code is a QR code.

23. The method for creating, publishing, and disseminating a data-file in real time, wherein the data-file has a finite life cycle and is stored in an internet-connected database that is searchable by one or more end users and by a creator of the data-file as recited in claim 19, further comprising the steps of:
requesting an email address from each of the one or more end users;
storing the email address from each of the one or more end-user customers; and
communicating the email address from each of the one or more end-user customers to the creator of the data-file.

24. The method for creating, publishing, and disseminating a data-file in real time, wherein the data-file has a finite life cycle and is stored in an internet-connected database that is searchable by one or more end users and by a creator of the data-file as recited in claim 19, further comprising the steps of:
determining when the data-file circulation quantity has been reached; and
removing the data-file from the internet-connected database when the data-file circulation quantity has been reached.

25. The method for creating, publishing, and disseminating a data-file in real time, wherein the data-file has a finite life cycle and is stored in an internet-connected database that is searchable by one or more end users and by a creator of the data-file as recited in claim 19, wherein the step of presenting the data-file to the one or more end users includes the steps of:
receiving one or more search criteria from the one or more end users;
determining a set of qualifying data-files from the internet-connected database based upon the one or more search criteria; and
displaying the set of qualifying data-files to the one or more end users, wherein the set of qualifying data-files corresponds to a subset of active data-files stored in the internet-connected database that match the one or more search criteria.
